(19) United States
(12) Patent Application Publication
(10) Pub. No.: US 2008/0081187 A1
(43) Pub. Date: Apr. 3, 2008

(54) Compound Material, In Particular For Clothes, Fashion Industry and Furniture

(75) Inventor: Maurizio LONGATI, S. Lazzaro di Savena (Bologna) (IT)

Correspondence Address: WILLIAM J. SAPONE;COLEMAN SUDOL SAPONE P.C., 714 COLORADO AVENUE, BRIDGE PORT, CT, 06605, US

(73) Assignee: MOMABOMA S.R.L., S. Lazzaro di Savena (Bologna) (IT)

(21) Appl. No.: 11/859,018

(22) Filed: Sep. 21, 2007

(30) Foreign Application Priority Data
Sep. 29, 2006 (IT) BO2006A 000669

(51) Int. Cl. B32B 7/12

(52) U.S. Cl. 428/346; 428/354

(57) ABSTRACT

In a compound material, in particular for fashion, clothes and furniture, one first flexible thermoplastic material support is covered by a covering layer formed by a plurality of portions, set close to one another, deriving from recycled materials. A first layer of glue is applied between the first flexible support and the covering layer to ensure mutual adherence between the first flexible support and the covering layer.

### FIELD OF THE INVENTION

The present invention relates to materials for fashion, clothes and furniture.

In this particular case, the present invention relates to a compound material for manufacturing of clothes accessories, such as gloves, headdresses, pockets, loops, belts, watch straps and bracelets; fashion articles, such as bags, purses, wallets, cell phone cases, key rings and similar accessories, padding for folders, suitcases and briefcases; as well as furniture elements, such as covers, fillings, cushions and drapes.

### DESCRIPTION OF THE PRIOR ART

It is known that most of the clothes articles and accessories, such as bags, purses, wallets are obtained using fabrics, leather, hide and leather and hide imitations.

These materials can be used combined together, substantially in order to increase the aesthetic value of the articles and/or accessories.

Recently, use of recyclable materials for manufacturing articles, accessories and inserts has been widely spread in the fashion and clothes fields.

A considerable disadvantage in the use of recyclable materials derives from their difficult processing during stitching and/or assembling, for example with buckles, buttons, handles, etc.

Some of them, considered individually, are little resistant to mechanical stresses, such as for example wear and tear, and/or to the atmospheric stresses, and suffer particularly from high humidity.

### SUMMARY OF THE INVENTION

The object of the present invention is to obviate the above mentioned disadvantages by proposing a compound material, in particular for fashion, clothes and furniture, obtained from recycled materials, preferably flexible thermoplastic, paper, metallic, biodegradable organic, which can give the articles and accessories a considerable aesthetic value and a concurrent, pleasant “vintage” effect.

Another object of the present invention is to propose a compound material for manufacturing articles, inserts and accessories for fashion, clothes and furniture, which allows particularly easy and rapid stitching and assembling steps.

Moreover, the present invention proposes an aesthetically captivating compound material, which can ensure best resistance to mechanical and/or atmospheric stresses, implying at the same time a beneficial environmental impact.

The above mentioned objects are obtained, in accordance with the contents of the claims, by a compound material, in particular for fashion, clothes and furniture, including:

at least one first flexible support of thermoplastic material; at least one covering layer of the first flexible support, including a plurality of portions, set close to one another, deriving from recycled materials;

at least one first layer of glue applied between the first flexible support and the covering layer, to ensure mutual adherence between the first flexible support and the covering layer.

### BRIEF DESCRIPTION OF THE DRAWINGS

The characteristic features of the invention will be pointed out in the following description of some preferred but not exclusive embodiments, with reference to the enclosed figures, in which:

FIGS. 1, 2 are schematic, top and lateral views, respectively, of a preferred embodiment of the compound material proposed by the present invention;

FIGS. 3, 4 are as many schematic lateral, exploded views of the proposed compound material, according to corresponding further embodiments.

### DISCLOSURE OF THE PREFERRED EMBODIMENTS

Having regard to the above mentioned Figures, reference (M) indicates the proposed compound material, particularly indicated for manufacturing of articles, accessories and inserts for fashion, clothes and furniture.

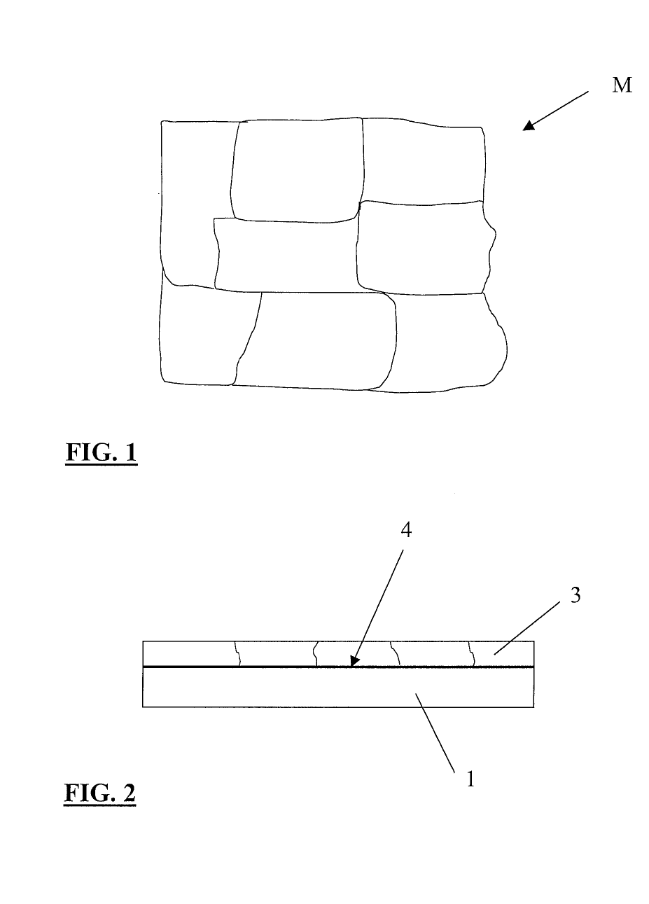

According to a preferred embodiment, shown in FIGS. 1 and 2, the proposed compound material (M) includes at least a first flexible support (1) of thermoplastic material, at least one covering layer (3), comprising a plurality of portions, close to one another and deriving from recycled materials, at least one first layer of glue (4), interposed between the first flexible support (1) and the covering layer (3), for mutual adherence thereof.

The covering layer (3) is laid on the first flexible support (1), covering it at least partially, preferably all of it.

The first flexible support (1) of thermoplastic material is made of one of the materials advantageously selected from the group including PE, PET, PVC, PP, PS, and can include either an interwoven weft or a continuous sheet.

According to a preferred embodiment, the first flexible support (1) includes one or more sheets of foam rubber, an extremely soft and light material.

The covering layer (3) includes a plurality of portions, set close to one another, of thermoplastic, and/or paper, and/or organic biodegradable, and/or metallic material, considered either combined together or individually.

This means that the covering layer (3) can be obtained by close portions of thermoplastic, or paper, or organic biodegradable, or metallic material, and likewise it can be obtained by close portions of thermoplastic and paper materials, or thermoplastic and metallic materials, or thermoplastic, paper and metallic materials, and so on, in relation to the specific technical-aesthetic requirements.

In particular, for example, the organic biodegradable material can include plant leaves and/or rinds.

Likewise, still for example, the paper material deriving from the recycled materials can be formed by films and/or layers obtained from commercial labels and/or school exercise books and/or magazine sheets, and/or bags and/or containers and/or food and/or agriculture wrappings.

One mentions, for example, the commercial paper labels applied to containers, boxes, cans, bottles, etc., containing food and non-food stuff; paper sacks for cement, fertilizers, manure, etc.; paper bags and/or cardboard boxes for food stuff, like pasta, rice, confectionery products, biscuits, snacks, beverages, fruit juices, drinks, etc.; paper packaging of mono- and multi-product packs, etc.

Still for example, the metallic material deriving from the recycled objects can be formed by flexible films and/or sheets of aluminum, preferably for food and/or agriculture use.

One mentions, for example, sacks of aluminum for preserving foodstuffs, like coffee, various salamis, confectionery products; yogurt plastic wraps, container vacuum covers, etc.; metallic packaging for mono- and multi-product packs, etc.

Likewise, for example, the thermoplastic material deriving from the recycled objects is flexible and formed by films and/or sheets obtained beginning from commercial labels, and/or bags, and/or containers, and/or wrappings preferably for food and/or agriculture use, preferably made of at least one material among PE, PET, PVC, PP, PS.

One mentions, for example, the commercial paper labels applied to containers, boxes, cans, bottles containing foodstuffs, etc.; transparent, semitransparent and opaque bags, containing fresh and/or long-life foodstuffs; bags for agricultural products, such as fertilizers, manure, seeds etc.; transparent, semi-transparent and opaque impermeable tarpaulins; bags for garbage, foodstuff, products and goods, etc.; thermoplastic packaging of mono- and multi-product packs, etc.

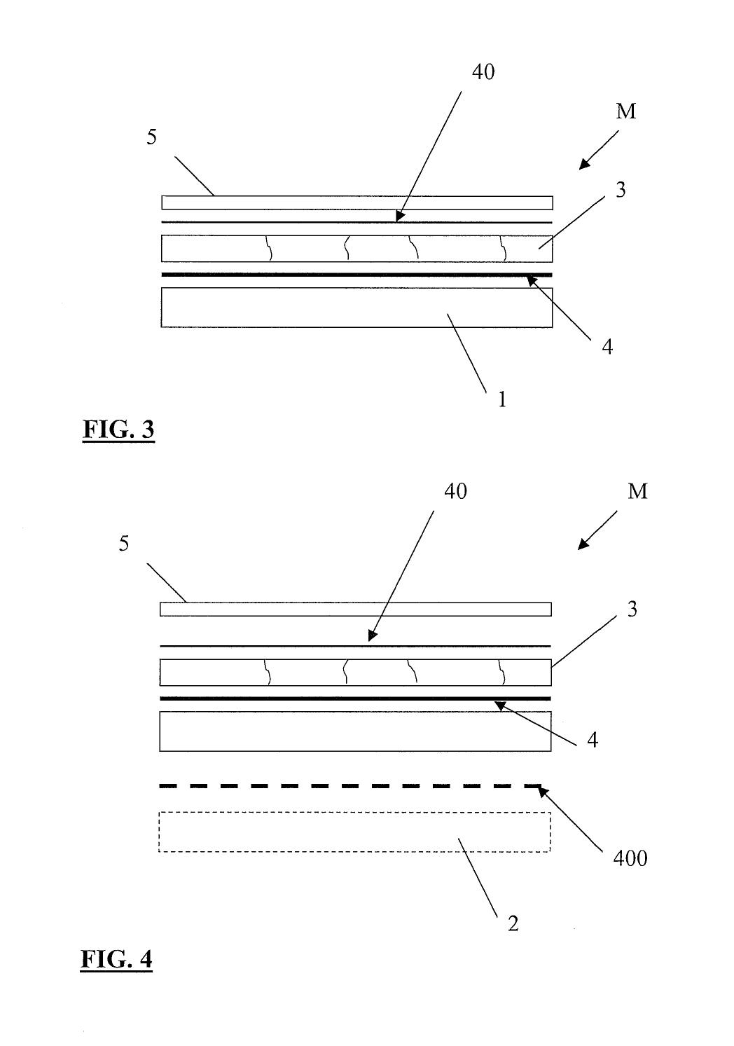

According to a further embodiment, shown in FIG. 3, the proposed compound material (M) includes also a protective layer (5), placed over the covering layer (3), associated thereto by a second layer of glue (40).

The protective layer (5) is at least semitransparent, preferably transparent.

For example, it is formed by a flexible thermoplastic film, e.g. deriving from recycled bags, preferably of PE or PVC, for containing garbage, foodstuff, products and goods, etc.

According to another embodiment, shown in FIG. 4, the proposed compound material (M) includes also a couple of flexible supports, first (1) and second (2), mutually connected by means of stitching or a third layer of glue (400).

For example, the first flexible support (1), connected directly to the covering layer (3), can be made of thermoplastic material, selected from the group including PE, PET, PVC, PP, PS, e.g. formed by an interwoven weft, while the second flexible support (2) can be formed by one or more sheets of foam rubber.

In this case the first flexible, interwoven support (1) gives the mechanical resistance, while the second support (2) of foam rubber gives flexibility, softness and lightness.

The above mentioned layers of glue (4, 40, 400) are advantageously of bi-adhesive type, or of thermo-activated type, or are obtained by application of adhesive material by spreading or spraying.

The compound material (M) is advantageously subjected to hot pressing, in order to increase and/or stabilize the adhesion between the first flexible support (1) and the covering layer (3), possibly between the latter and the protective layer (5), possibly between the two flexible supports (1, 2).

The hot pressing is preferably obtained by introducing the compound material (M) between a pair of counter-rotating rolls, heated to a temperature between 70 and 150° C., preferably included between 80 and 90° C., with a maximum speed of 50 cm per minute, preferably of 40 cm per minute.

The proposed compound material (M) is particularly indicated for obtaining clothes accessories, such as gloves, headdresses, pockets, loops, belts, watch straps and bracelets; fashion articles, such as bags, purses, wallets, cell phone cases, key rings and similar accessories, padding for folders, suitcases and briefcases; as well as furniture elements, such as covers, fillings, cushions and drapes.

Therefore, it can be understood how the proposed compound material, particularly indicated for fashion, clothes and furniture, obtained beginning from recycled materials, preferably flexible thermoplastic, paper, metallic, biodegradable organic, can give the articles and accessories a considerable aesthetic value and a concurrent, pleasant “vintage” effect.

This allows to obtain articles, inserts and accessories for fashion, clothes and furniture, by particularly easy and rapid stitching and assembling steps, implying at the same time a beneficial environmental impact for the used materials, which are thus recycled.

The presence of the flexible support, single or double, or multiple, together with the presence of the protection layer, allows ensuring an optimal resistance to the mechanical and/or atmospheric stresses.

In particular, the articles, inserts and accessories, produced of this compound material, will be especially resistant to the effects of the sun, water and wind.

1. A compound material, in particular for fashion, clothes and furniture, including:
at least one first flexible support of thermoplastic material;
at least one covering layer of the first flexible support, including a plurality of portions, set close to one another, deriving from recycled materials;
at least one first layer of glue applied between the first flexible support and the covering layer, to ensure mutual adherence between the first flexible support and the covering layer.

2. A compound material, according to claim 1, wherein the covering layer covers the first flexible support at least partially, preferably entirely.

3. A compound material, according to claim 2, wherein the first layer of glue is a biadhesive layer, or a thermo-activated adhesive, or is obtained by application of adhesive material by spreading or spraying.

4. A compound material, according to claim 1, further including at least one protective layer, placed over the covering layer, associated to the covering layer by means of a second layer of glue.

5. A compound material, according to claim 4, wherein the protective layer is at least semitransparent, preferably transparent.

6. A compound material, according to claim 4, wherein the protective layer includes a flexible, thermoplastic film.

7. A compound material, according to claim 6, wherein the thermoplastic film derives from recycled bags, preferably in PE or PVC.

8. A compound material, according to claim 4, wherein the second layer of glue is a biadhesive layer, or a thermo-activated adhesive, or is obtained by application of adhesive material by spreading or spraying.

9. A compound material, according to claim 1, wherein the covering layer includes a plurality of portions, set close one to another, of thermoplastic, and/or paper, and/or organic biodegradable, and/or metallic material, considered combined together or individually.

10. A compound material, according to claim 9, wherein said organic biodegradable material includes plant leaves or rinds.

11. A compound material, according to claim 9, wherein said paper material deriving from the recycled materials can be formed by films and/or layers obtained beginning from school exercise books, and/or magazine sheets, and/or commercial labels, and/or bags, and/or containers, and/or wrappings preferably for food and/or agriculture use.

12. A compound material, according to claim 9, wherein said metallic material deriving from the recycled materials can be formed by flexible films and/or sheets of aluminum preferably for food and/or agriculture use.

13. A compound material, according to claim 9, wherein said thermoplastic material deriving from the recycled materials is flexible.

14. A compound material, according to claim 13, wherein said thermoplastic material is formed by films and/or sheets obtained beginning from bags and/or commercial labels, and/or containers, and/or wrappings preferably for food and/or agriculture use, preferably made of at least one material among PE, PET, PVC, PP, PS.

15. A compound material, according to claim 1, wherein said first flexible support of thermoplastic material is made of a material selected from the group including PE, PET, PVC, PP, PS.

16. A compound material, according claim 1, wherein said first flexible support is formed by an interwoven weft or a continuous sheet.

17. A compound material, according to claim 1, wherein said first flexible support is formed by sheets of foam rubber.

18. A compound material, according to claim 1, further including a couple of flexible supports, first and second, mutually connected by means of stitching or a third layer of glue.

19. A compound material, according to claim 18, wherein the third layer of glue is a biadhesive layer, or a thermo-activated adhesive, or is obtained by application of adhesive material by spreading or spraying.
